(19) United States
(12) Patent Application Publication
(10) Pub. No.: US 2026/0031555 A1
(43) Pub. Date: Jan. 29, 2026

(54) Terminal, Electrical Connection Module And Connector

(71) Applicant: Tyco Electronics (Shanghai) Co., Ltd., Shanghai (CN)

(72) Inventors: Dingbing (Frank) Fan, Shanghai (CN); Ming Shi, Shanghai (CN); Xiaozhi (George) Fu, Shanghai (CN); Wei Zhang, Shanghai (CN); Zhao Cheng, Shanghai (CN); Shuzhi (Lorry) Wang, Shanghai (CN)

(73) Assignee: Tyco Electronics (Shanghai) Co., Ltd., Shanghai (CN)

(21) Appl. No.: 19/278,081

(22) Filed: Jul. 23, 2025

(30) Foreign Application Priority Data
Jul. 23, 2024 (CN) 202421753620.8

(51) Int. Cl. H01R 11/11; H01R 4/18; H01R 13/432; H01R 13/436

(52) U.S. Cl. CPC H01R 11/11; H01R 4/185; H01R 13/432; H01R 13/4361

(57) ABSTRACT

A terminal includes a primary locking tab and a mating portion having front and rear end portions. The front end portion has a front annular portion and a front reinforcement portion. The front annular portion has a first top wall, a first bottom wall, and a pair of first side walls. The front reinforcement portion has a first bottom plate, a first side plate, and a first engagement plate. The first side plate and the first engagement plate are located on one of two sides of the first bottom plate. The primary locking tab extends obliquely rearward and upward from the front end portion. A root portion of the primary locking tab is connected to a rear side of the first top wall. The first bottom plate abuts an outer side of the first bottom wall. The first side plate, connected to the first top wall, abuts an outer side of one first side wall. The first engagement plate engages with an other first side wall.

### CROSS-REFERENCE TO RELATED APPLICATION

This application claims the benefit of the filing date under 35 U.S.C. § 119 (a)-(d) of Chinese Patent Application No. CN202421753620.8 filed on Jul. 23, 2024, the whole disclosure of which is incorporated herein by reference.

### FIELD OF THE INVENTION

The present invention relates to a terminal and, more particularly, to a terminal, an electrical connection module including the terminal, and a connector including the electrical connection module.

### BACKGROUND OF THE INVENTION

In the prior art, a primary locking tab is formed on a terminal of a connector, and the primary locking tab is locked in a housing of the connector to lock the terminal in the housing. The primary locking tab is connected to a front end portion of the terminal and extends obliquely upward and rearward. The front end portion of the existing terminal is of a single-layer annular structure that has poor strength, which results in easy disengagement of the primary locking tab from the housing. In addition, in the prior art, a secondary lock mounted in the housing abuts against a rear end surface of a mating portion of the terminal to further lock the terminal in the housing. The rear end of the existing mating portion is of a single-layer annular structure that has poor strength and is prone to deformation, which also results in easy disengagement of the terminal from the secondary lock. In addition, in the prior art, the terminal of the connector typically has only a single cantilever and a single electrical contact formed on the single cantilever, which results in unstable and unreliable electrical contact between the terminal of the connector and the terminal of the mating connector.

### SUMMARY OF THE INVENTION

A terminal includes a mating portion and a primary locking tab. The mating portion mates with a mating terminal and has a front end portion and a rear end portion opposite each other in a longitudinal direction of the mating portion. The front end portion has a front annular portion and a front reinforcement portion. The front annular portion has a first top wall, a first bottom wall, and a pair of first side walls. The front reinforcement portion enhances a structural strength of the front annular portion and has a first bottom plate, a first side plate, and a first engagement plate. The first side plate and the first engagement plate are each located on one of two sides of the first bottom plate. The primary locking tab extends obliquely rearward and upward from the front end portion and locks into a housing of a connector to lock the terminal in the housing. A root portion of the primary locking tab is connected to a rear side of the first top wall. The first bottom plate abuts against an outer side of the first bottom wall. The first side plate abuts against an outer side of one first side wall and is connected to the first top wall. The first engagement plate engages with an other first side wall.

### BRIEF DESCRIPTION OF DRAWINGS

The invention will now be described by way of example with reference to the accompanying figures, of which:

FIG. 1 is a top perspective view of a terminal according to an exemplary embodiment;

FIG. 2 is another top perspective view of the terminal of FIG. 1;

FIG. 3 is a bottom perspective view of the terminal of FIG. 1;

FIG. 4 is a longitudinal sectional view of a mating portion of the terminal of FIG. 1;

FIG. 5 is a longitudinal sectional view of the terminal of FIG. 1 when the mating portion of FIG. 4 mates with a mating terminal;

FIG. 6 is an exploded view of a connector according to an exemplary embodiment;

FIG. 7 is a perspective view of the connector of FIG. 6; and

FIG. 8 is a longitudinal sectional view of the connector of FIG. 6.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

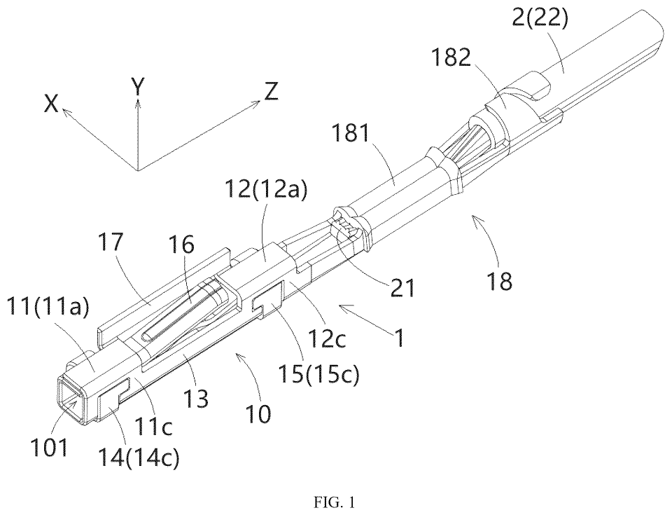

An exemplary embodiment of a terminal 1 will now be described with reference to FIGS. 1-8. The terminal 1 is an integral stamped part. For example, the terminal 1 can be made by stamping a single sheet of metal stock.

As shown in FIG. 1, the terminal 1 includes a mating portion 10 and a primary locking tab 16. The mating portion 10 is configured to mate with a mating terminal 1′ and has a front end portion and a rear end portion opposite each other in a longitudinal direction Y thereof. As shown in FIGS. 1-2 and 8, the primary locking tab 16 extends obliquely rearward and upward from the front end portion of the mating portion 10. The primary locking tab 16 is configured to lock into a housing 3 of a connector to lock the terminal 1 in the housing 3.

As shown in FIG. 1, the front end portion of the mating portion 10 includes a front annular portion 11 and a front reinforcement portion 14. As shown in FIGS. 1-4, the front annular portion 11 includes a first top wall 11a, a first bottom wall 11b, and a pair of first side walls 11c. The front reinforcement portion 14 is configured to enhance a structural strength of the front annular portion 11, and includes, as shown in FIGS. 1-4, a first bottom plate 14b, and a first side plate 14a and a first engagement plate 14c which are located on two sides of the first bottom plate 14b. A root portion of the primary locking tab 16 is connected to a rear side of the first top wall 11a, the first bottom plate 14b abuts against an outer side of the first bottom wall 11b, the first side plate 14a abuts against an outer side of one of the first side walls 11c and is connected to the first top wall 11a, and the first engagement plate 14c engages with the other first side wall 11c.

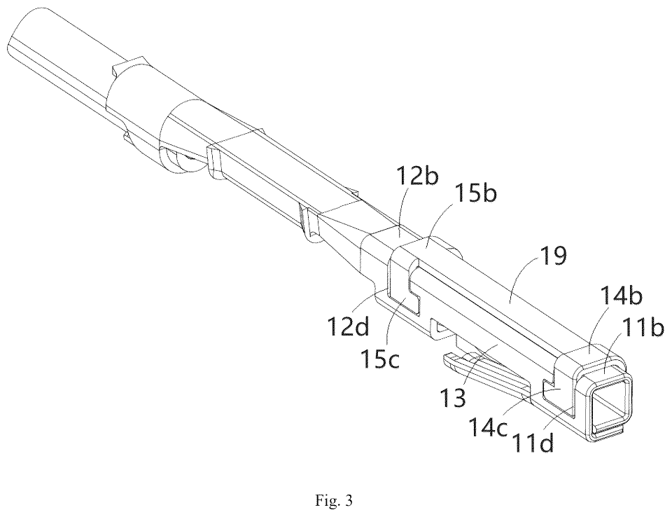

As shown in FIGS. 1-3, the front reinforcement portion 14 is U-shaped, and an upper side of the first side plate 14a is connected to a side edge of the first top wall 11a. As shown in FIG. 3, a first engagement groove 11d is formed in the other first side wall 11c, and the first engagement plate 14c engages into the first engagement groove 11d in the other first side wall 11c. The first engagement plate 14c and the first engagement groove 11d in the other first side wall 11c form an L shape, a T shape, or an (2 shape.

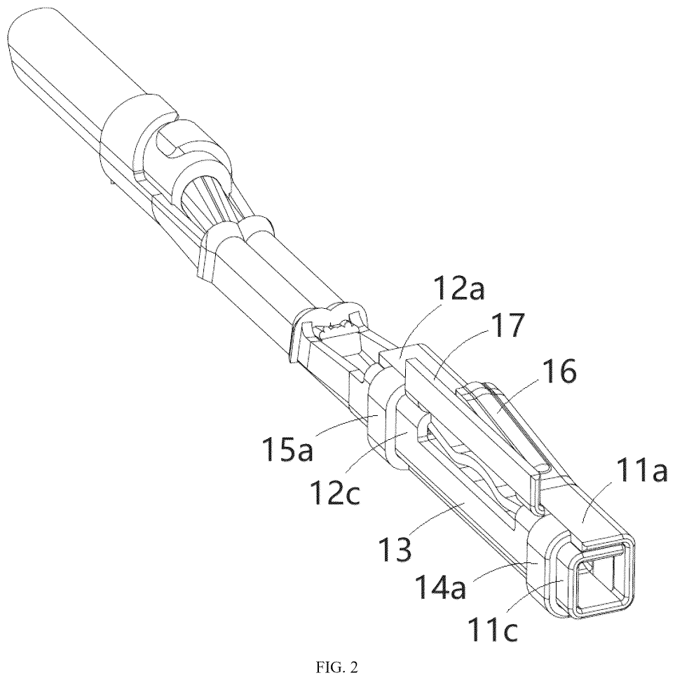

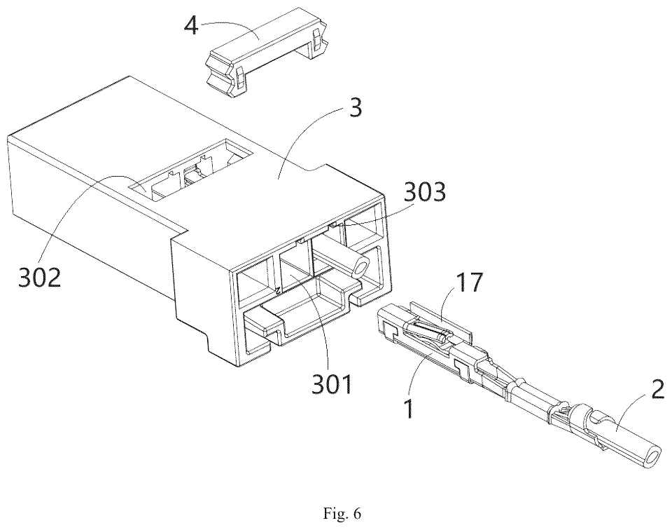

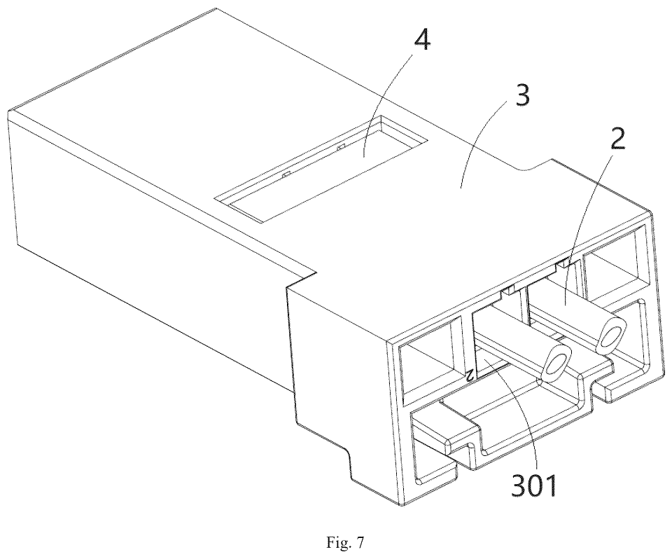

As shown in FIG. 1, the rear end portion of the mating portion 10 includes a rear annular portion 12 and a rear reinforcement portion 15. The rear annular portion 12 includes a second top wall 12a, as shown in FIGS. 1-2, 4, and 8, a second bottom wall 12b, as shown in FIG. 3, and a pair of second side walls 12c, as shown in FIGS. 1-2. The rear reinforcement portion 15 is configured to enhance a structural strength of the rear annular portion 12, and, as shown in FIGS. 1-3, includes a second bottom plate 15b, and a second side plate 15a and a second engagement plate 15c which are located on two sides of the second bottom plate 15b. A rear side of the second top wall 12a is configured to abut against a secondary lock 4, as shown in FIGS. 6-8, of the connector to lock the terminal 1 in the housing 3. The second bottom plate 15b abuts against an outer side of the second bottom wall 12b, the second side plate 15a abuts against an outer side of one of the second side walls 12c and is connected to the second top wall 12a, and the second engagement plate 15c engages with the other second side wall 12c.

As shown in FIGS. 2-3, the rear reinforcement portion 15 is U-shaped, and an upper side of the second side plate 15a is connected to a side edge of the second top wall 12a. A second engagement groove 12d, as shown in FIG. 3, is formed in the other second side wall 12c, and the second engagement plate 15c engages into the second engagement groove 12d in the other second side wall 12c. The second engagement plate 15c and the second engagement groove 12d in the other second side wall 12c form an L shape, a T shape, or an Ω shape.

As shown in FIG. 3, the mating portion 10 of the terminal 1 further includes a main body portion 13 and a reinforcement plate 19. The main body portion 13 extends in a longitudinal direction Y of the terminal 1 and is connected between the front annular portion 11 and the rear annular portion 12. The reinforcement plate 19 extends in the longitudinal direction Y of the terminal 1 and is connected between the first bottom plate 14b and the second bottom plate 15b. The main body portion 13 has a U-shaped cross section that is open at the top, and the reinforcement plate 19 abuts against a bottom portion of the main body portion 13.

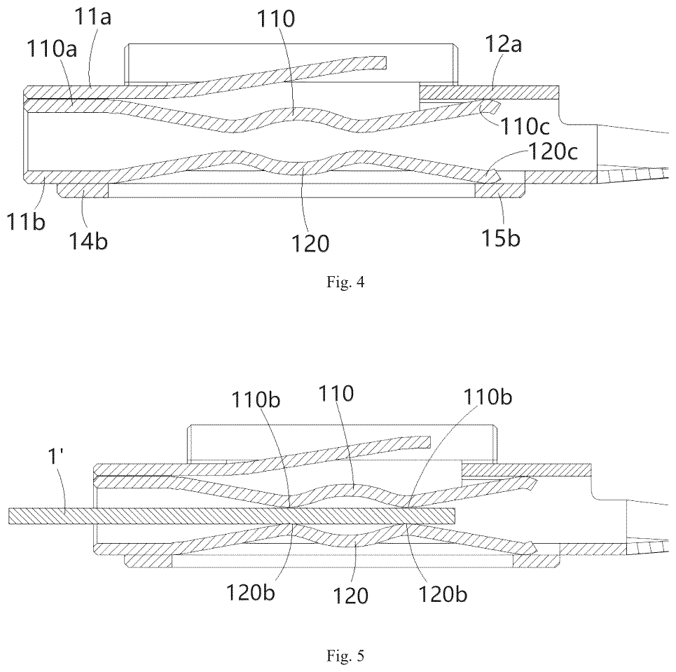

As shown in FIG. 1, the mating portion 10 of the terminal 1 has an insertion cavity 101 extending in the longitudinal direction Y of the terminal 1. The insertion cavity 101 allows insertion of the mating terminal 1′, and includes a first cantilever 110, as shown in FIGS. 4-5, located in the insertion cavity 101. As shown in FIG. 5, the first cantilever 110 has a plurality of protruding first electrical contacts 110b. The plurality of first electrical contacts 110b are spaced apart from each other in the longitudinal direction Y and are configured to simultaneously make electrical contact with one side of the mating terminal 1′ inserted into the insertion cavity 101.

As shown in FIGS. 4-5, the mating portion 10 of the terminal 1 further includes a second cantilever 120 located in the insertion cavity 101, and the first cantilever 110 and the second cantilever 120 are spaced apart from and arranged opposite each other in a height direction Z of the mating portion 10. As shown in FIG. 5, the second cantilever 120 has a plurality of protruding second electrical contacts 120b. The plurality of second electrical contacts 120b are spaced apart from each other in the longitudinal direction Y and are configured to simultaneously make electrical contact with the other side of the mating terminal 1′ inserted into the insertion cavity 101.

A fixing end 110a of the first cantilever 110 is connected to an upper side edge of the first side wall 11c and, as shown in FIG. 4, abuts against an inner side of the first top wall 11a. As shown in FIG. 4, the first cantilever 110 has a first free end 110c abutting against an inner side of the second top wall 12a. A root portion of the second cantilever 120 is connected to a rear side of the first bottom wall 11b. As shown in FIG. 4, the second cantilever 120 has a second free end 120c abutting against an inner side of the second bottom plate 15b. As shown in FIG. 5, the plurality of first electrical contacts 110b on the first cantilever 110 respectively correspond to and are aligned with the plurality of second electrical contacts 120b on the second cantilever 120 in the height direction Z.

As shown in FIGS. 1-2 and 6, the mating portion 10 of the terminal 1 further includes a guide plate 17. The guide plate 17 extends in the longitudinal direction Y of the terminal 1 and is perpendicular to a transverse direction X of the terminal 1. The guide plate 17 is located on one side of the mating portion 10 in the transverse direction X, and is configured to cooperate with a guide groove 303 in the housing 3 to guide insertion of the terminal 1 into the housing 3 in a correct orientation. As shown in FIG. 1, the guide plate 17 is located above the first top wall 11a and the second top wall 12a, a lower side of a front end of the guide plate 17 is connected to the first top wall 11a, and a lower side of a rear end of the guide plate 17 is connected to the second top wall 12a.

As shown in FIG. 1, the terminal 1 further includes a crimping portion 18. The crimping portion 18 is configured to be crimped onto a cable 2. The crimping portion 18 is connected to a rear side of the rear annular portion 12 of the mating portion 10 and extends rearward from the rear annular portion 12. The crimping portion 18 includes, as shown in FIG. 1, a first crimping portion 181 and a second crimping portion 182. The first crimping portion 181 is configured to be crimped onto a conductor core 21 of the cable 2. The second crimping portion 182 is configured to be crimped onto an outer covering layer 22 of the cable 2. The first crimping portion 181 is located between the mating portion 10 and the second crimping portion 182.

An exemplary embodiment of an electrical connection module will now be described with reference to FIGS. 1-8. As shown in FIGS. 1 and 6, the electrical connection module includes the terminal 1 as described above, and a cable 2 electrically connected to the terminal 1 at one end. For example, as shown in FIG. 1, the crimping portion 18 of the terminal 1 is crimped onto one end of the cable 2.

An exemplary embodiment of a connector will now be described with reference to FIGS. 1-8. As shown in FIG. 6, the connector includes a housing 3, the above terminal 1 or the above electrical connection module, and a secondary lock 4. The housing 3 has a terminal insertion hole 301, as shown in FIGS. 6-7, extending in a longitudinal direction Y thereof and a secondary lock insertion slot 302, as shown in FIG. 6, extending in a transverse direction X thereof and in communication with the terminal insertion hole 301. The terminal 1 or the electrical connection module is inserted into the terminal insertion hole 301. The secondary lock 4 is inserted into the secondary lock insertion slot 302 and abuts against a mating portion 10 of the terminal 1 in the longitudinal direction Y to lock the terminal 1 in the terminal insertion hole 301.

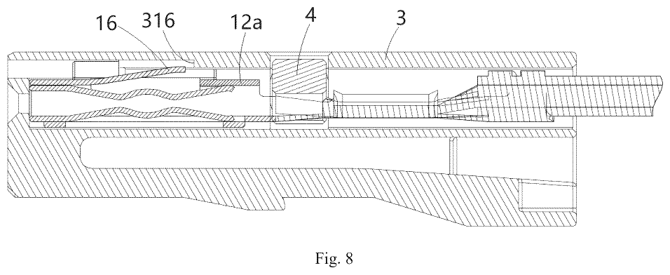

As shown in FIG. 8, a stop step 316 perpendicular to the longitudinal direction Y is formed in the housing 3, and the stop step 316 is adapted to abut against a rear end of a primary locking tab 16 of the terminal 1 to lock the terminal 1 in the terminal insertion hole 301. A guide groove 303, as shown in FIG. 6, extending in the longitudinal direction Y is formed in the housing 3. The guide groove 303 is configured to cooperate with a guide plate 17 on the terminal 1 to guide insertion of the terminal 1 into the housing 3 in a correct orientation.

As shown in FIGS. 6-7, a plurality of terminal insertion holes 301 are formed in the housing 3, and the secondary lock insertion slot 302 is in communication with the plurality of terminal insertion holes 301. The connector includes a plurality of terminals 1, the plurality of terminals 1 are respectively inserted into the plurality of terminal insertion holes 301, and the secondary lock 4 is adapted to simultaneously abut against the plurality of terminals 1 to simultaneously lock the plurality of terminals 1 in the housing 3.

In the aforementioned exemplary embodiments, the mating portion 10 of the terminal 1 has reinforcement structures at both the front end portion and the rear end portion, which improves the structural strength of the front end portion and the rear end portion of the mating portion 10 and can ensure that the terminal 1 is reliably locked in the housing 3.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present utility model are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a mating portion mating with a mating terminal and having a front end portion and a rear end portion opposite each other in a longitudinal direction of the mating portion, the front end portion has a front annular portion and a front reinforcement portion, the front annular portion has a first top wall, a first bottom wall, and a pair of first side walls, the front reinforcement portion enhances a structural strength of the front annular portion and has a first bottom plate, a first side plate, and a first engagement plate, the first side plate and the first engagement plate are each located on one of two sides of the first bottom plate; and
a primary locking tab extending obliquely rearward and upward from the front end portion and locking into a housing of a connector to lock the terminal in the housing, a root portion of the primary locking tab is connected to a rear side of the first top wall, the first bottom plate abuts against an outer side of the first bottom wall, the first side plate abuts against an outer side of one first side wall and is connected to the first top wall, and the first engagement plate engages with an other first side wall.

2. The terminal of claim 1, wherein the front reinforcement portion is U-shaped, and an upper side of the first side plate is connected to a side edge of the first top wall, a first engagement groove is formed in the other first side wall, and the first engagement plate engages into the first engagement groove in the other first side wall.

3. The terminal of claim 2, wherein the first engagement plate and the first engagement groove in the other first side wall form an L shape, a T shape, or an Ω shape.

4. The terminal of claim 1, wherein the rear end portion of the mating portion has a rear annular portion and a rear reinforcement portion, the rear annular portion has a second top wall, a second bottom wall, and a pair of second side walls, the rear reinforcement portion enhances a structural strength of the rear annular portion and has a second bottom plate, a second side plate, and a second engagement plate, the second side plate and the second engagement plate are each located on one of two sides of the second bottom plate, a rear side of the second top wall abuts against a secondary lock of the connector to lock the terminal in the housing, the second bottom plate abuts against an outer side of the second bottom wall, the second side plate abuts against an outer side of one second side wall and is connected to the second top wall, and the second engagement plate engages with an other second side wall.

5. The terminal of claim 4, wherein the rear reinforcement portion is U-shaped, and an upper side of the second side plate is connected to a side edge of the second top wall, a second engagement groove is formed in the other second side wall, and the second engagement plate engages into the second engagement groove in the other second side wall.

6. The terminal of claim 5, wherein the second engagement plate and the second engagement groove in the other second side wall form an L shape, a T shape, or an Ω shape.

7. The terminal of claim 4, wherein the mating portion has a main body portion and a reinforcement plate, the main body portion extends in a longitudinal direction of the terminal and is connected between the front annular portion and the rear annular portion, the reinforcement plate extends in the longitudinal direction of the terminal and is connected between the first bottom plate and the second bottom plate, the main body portion has a U-shaped cross section that is open at the top, and the reinforcement plate abuts against a bottom portion of the main body portion.

8. The terminal of claim 4, wherein the mating portion has an insertion cavity extending in a longitudinal direction of the terminal, the insertion cavity allows insertion of the mating terminal and has a first cantilever in the insertion cavity, the first cantilever has a plurality of protruding first electrical contacts, the plurality of first electrical contacts are spaced apart from each other in the longitudinal direction of the terminal and simultaneously make electrical contact with one side of the mating terminal inserted into the insertion cavity.

9. The terminal of claim 8, wherein the mating portion has a second cantilever in the insertion cavity, the first cantilever and the second cantilever are spaced apart from and arranged opposite each other in a height direction of the mating portion, the second cantilever has a plurality of protruding second electrical contacts, the plurality of second electrical contacts are spaced apart from each other in the longitudinal direction of the terminal and simultaneously make electrical contact with an other side of the mating terminal inserted into the insertion cavity.

10. The terminal of claim 9, wherein a fixing end of the first cantilever is connected to an upper side edge of one first side wall and abuts against an inner side of the first top wall, the first cantilever has a first free end abutting against an inner side of the second top wall, a root portion of the second cantilever is connected to a rear side of the first bottom wall, and the second cantilever has a second free end abutting against an inner side of the second bottom plate.

11. The terminal of claim 9, wherein the plurality of first electrical contacts respectively correspond to and are aligned with the plurality of second electrical contacts in the height direction.

12. The terminal of claim 1, wherein the mating portion of the terminal has a guide plate extending in the longitudinal direction of the terminal and perpendicular to a transverse direction of the terminal, the guide plate is on one side of the mating portion in the transverse direction, the guide plate cooperates with a guide groove in the housing to guide insertion of the terminal into the housing in a correct orientation.

13. The terminal of claim 12, wherein the guide plate is above the first top wall and a second top wall of a rear annular portion of the rear end portion, a lower side of a front end of the guide plate is connected to the first top wall, and a lower side of a rear end of the guide plate is connected to the second top wall.

14. The terminal of claim 1, further comprising a crimping portion crimped onto a cable, the crimping portion is connected to a rear side of a rear annular portion of the mating portion and extends rearward from the rear annular portion.

15. The terminal of claim 14, wherein the crimping portion has a first crimping portion crimped onto a conductor core of the cable, and a second crimping portion crimped onto an outer covering layer of the cable, the first crimping portion is between the mating portion and the second crimping portion.

16. An electrical connection module, comprising:
a terminal including a mating portion and a primary locking tab, the mating portion mates with a mating terminal and has a front end portion and a rear end portion opposite each other in a longitudinal direction of the mating portion, the front end portion has a front annular portion and a front reinforcement portion, the front annular portion has a first top wall, a first bottom wall, and a pair of first side walls, the front reinforcement portion enhances a structural strength of the front annular portion and has a first bottom plate, a first side plate, and a first engagement plate, the first side plate and the first engagement plate are each located on one of two sides of the first bottom plate, the primary locking tab extends obliquely rearward and upward from the front end portion and locks into a housing of a connector to lock the terminal in the housing, a root portion of the primary locking tab is connected to a rear side of the first top wall, the first bottom plate abuts against an outer side of the first bottom wall, the first side plate abuts against an outer side of one first side wall and is connected to the first top wall, and the first engagement plate engages with an other first side wall; and
a cable electrically connected to the terminal at one end.

17. A connector, comprising:
a housing having a terminal insertion hole extending in a longitudinal direction of the housing and a secondary lock insertion slot extending in a transverse direction of the housing and in communication with the terminal insertion hole;
a terminal including a mating portion and a primary locking tab, the mating portion mates with a mating terminal and has a front end portion and a rear end portion opposite each other in a longitudinal direction of the mating portion, the front end portion has a front annular portion and a front reinforcement portion, the front annular portion has a first top wall, a first bottom wall, and a pair of first side walls, the front reinforcement portion enhances a structural strength of the front annular portion and has a first bottom plate, a first side plate, and a first engagement plate, the first side plate and the first engagement plate are each located on one of two sides of the first bottom plate, the primary locking tab extends obliquely rearward and upward from the front end portion and locks into the housing of the connector to lock the terminal in the housing, a root portion of the primary locking tab is connected to a rear side of the first top wall, the first bottom plate abuts against an outer side of the first bottom wall, the first side plate abuts against an outer side of one first side wall and is connected to the first top wall, and the first engagement plate engages with an other first side wall, or an electrical connection module including the terminal and a cable electrically connected to the terminal at one end, one of the terminal and the electrical connection module are inserted into the terminal insertion hole; and
a secondary lock inserted into the secondary lock insertion slot and abutting against the mating portion of the terminal in the longitudinal direction of the housing to lock the terminal in the terminal insertion hole.

18. The connector of claim 17, wherein a stop step perpendicular to the longitudinal direction of the housing is formed in the housing, the stop step abuts against a rear end of the primary locking tab of the terminal to lock the terminal in the terminal insertion hole.

19. The connector of claim 17, wherein a guide groove extending in the longitudinal direction of the housing is formed in the housing, the guide groove cooperates with a guide plate on the terminal to guide insertion of the terminal into the housing in a correct orientation.

20. The connector of claim 17, wherein a plurality of terminal insertion holes are formed in the housing, and the secondary lock insertion slot is in communication with the plurality of terminal insertion holes, and the connector has a plurality of terminals, each terminal is inserted into one terminal insertion hole, the secondary lock simultaneously abuts against each terminal to simultaneously lock each terminal in the housing.
